(19) United States
(12) Patent Application Publication
(10) Pub. No.: US 2004/0071919 A1
(43) Pub. Date: Apr. 15, 2004

(54) Pressure sensitive adhesive articles

(75) Inventors: Isao Sakurai, Saitama (JP); Tomishi Shibano, Saitama (JP)

Correspondence Address: BRINKS HOFER GILSON & LIONE, P.O. BOX 10395, CHICAGO, IL, 60611, US

(73) Assignee: LINTEC Corporation

(21) Appl. No.: 10/650,162

(22) Filed: Aug. 28, 2003

(30) Foreign Application Priority Data
Aug. 29, 2002 (JP) 2002-252156

(51) Int. Cl. B32B 9/00

(52) U.S. Cl. 428/41.8

(57) ABSTRACT

A pressure sensitive adhesive article which hardly gives adverse effects caused by silicone compound and which has an improved releasability that makes it possible to peel off a release sheet from a pressure sensitive adhesive layer with a small release force is provided. Such a pressure sensitive adhesive article 1A is constituted from a pressure sensitive adhesive sheet 2A and a release sheet 3A. The pressure sensitive adhesive sheet 2A comprises a base material 21 of the pressure sensitive adhesive sheet 2A and a pressure sensitive adhesive layer 22. The release sheet 3A comprises a release sheet base material 31 and a releasing agent layer 32. The releasing agent layer 32 is constituted of polyolefin resin having a density of 0.94 g/cm³ or less. A wetting tension at the surface of the releasing agent layer 32 which faces the pressure sensitive adhesive layer 22 measured according to JIS K 6768 is 33 mN/m or less.

### BACKGROUND OF THE INVENTION

1. Field of the Invention

This invention relates to pressure sensitive adhesive articles, and in particular to improved pressure sensitive adhesive articles such as pressure sensitive adhesive sheets (including pressure sensitive adhesive labels) with release sheets and pressure sensitive adhesive tapes and the like.

2. Description of the Prior Art

In general, pressure sensitive adhesive articles provided with pressure sensitive adhesive sheets have pressure sensitive adhesive layers, and release sheets having releasing-agent layers are removably attached to the pressure sensitive-adhesive layers for making handlability of the sheets easy (hereinafter, such an article comprised of a pressure sensitive adhesive sheet (label) and a release sheet removably attached thereto is referred to as “pressure sensitive adhesive sheet with a release sheet”). Further, in the case of pressure-sensitive adhesive articles such as pressure sensitive adhesive tapes, releasing agent layers are formed on back surfaces of base materials of the tapes which are opposite to another surfaces of the base materials on which pressure sensitive adhesive layers are provided.

Conventionally, in such pressure sensitive adhesive articles, the pressure sensitive adhesive layers are formed of poly(meth)acrylic ester based adhesives, natural rubber based adhesives, or synthetic rubber based adhesives, or the like. Most of these pressure sensitive adhesives are used in combination with release sheets having releasing agent layers made of silicone resins (silicone compounds).

However, in such pressure sensitive adhesive articles that are used in combination with the releasing agent layers made of silicone resins, there are the following problems.

### (1) Writability on the Surface of the Releasing Agent Layer

When a pressure sensitive adhesive tape is used for taping a cardboard box for packaging it, there is a case that information such as address or name of content is written onto the surface of the tape with ink. However, since the surface of the tape made of a silicone resin is repellent to ink, there is a case that such writing is difficult to carry out.

### (2) Slippage on the Surface of the Releasing Agent Layer

When a pressure sensitive adhesive tape is used for taping cardboard boxes for packaging them, there is a case that such packaged cardboard boxes are piled on a pallet or the like. In such a state, there is a case that the piled cardboard boxes are fallen down due to slippage at the surfaces of the releasing agent layers of the pressure sensitive adhesive tapes attached to the packaged cardboard boxes. Therefore, there is a demand for pressure sensitive adhesive tapes having releasing agent layers of lower slippage.

### (3) Transferring of Silicone Compound

It is known that when such a release sheet is attached to a pressure sensitive adhesive sheet, silicone compound such as low molecular weight silicone resin, siloxane and/or silicone oil contained in the releasing agent layer of the release sheet is transferred to the pressure sensitive adhesive layer of the pressure sensitive adhesive sheet. Further, normally, the release sheet is wound up in a rolled form after the production thereof, and in this state, the back surface of the release sheet (that is, the surface of a release sheet base material opposite to the surface of the release sheet base material where the releasing agent layer is formed) is in contact with the releasing agent layer thereof, so that the silicone compound contained in the releasing agent layer is transferred to the back surface of the release sheet. When a pressure sensitive adhesive sheet with a release sheet is manufactured using such a release sheet, the pressure sensitive adhesive sheet with a release sheet is also wound up in a rolled form. In connection with this, it is also known that the silicone compound transferred to the back surface of the release sheet is consequently transferred to the surface of a pressure sensitive adhesive sheet when winding up the pressure sensitive adhesive sheet with a release sheet in a rolled form.

The silicone compound which has been transferred to the surface of the pressure sensitive adhesive sheet is likely to give adverse effects to adhesion of ink when some characters or the like are printed on the surface of the pressure sensitive adhesive sheet by printing or thermal transfer printing. Further, such transferred silicone compound is also likely to make it difficult to write down some characters or the like onto the surface of the pressure sensitive adhesive sheet. In addition, when the silicone compound has been transferred to the back surface of the release sheet, there is a case that such silicone compound gives adverse effects to printing of characters or patterns or the like onto the back surface of the release sheet.

### (4) Contamination by Silicone Compound when used for Electronic Equipment

It is also known that when the pressure sensitive adhesive sheet to which such a release sheet has been attached is used for an adherend such as an electronic equipment (e.g. hard disk drives (HDD), semiconductor devices, relays and the like), the silicone compound which has been transferred to the pressure sensitive adhesive layer or the surface of the pressure sensitive adhesive sheet will gradually gasify, and then the gasified silicone compound will deposit on the surface of the adherend or the like, thereby forming a fine silicone resin layer (silicone compound layer). When such a silicone resin layer is formed on the electronic equipment such as hard disk drives (HDD), semiconductor devices, relays and the like which dislike contamination by such a silicone compound, there is a possibility that the silicone compound gives rise to adverse effects to the normal operations thereof or the precise formation of integrated circuits or the like.

In particular, in recent years, high performance and high density hard disk drives or semiconductor devices have been developed in a very short period of time, and it is believed that the tendency of seeking such high performance and high density will continue after this. If the tendency of such high performance and high density of hard disk drives or semiconductor devices continues further, there is a possibility that deposition of the fine silicone compound gives rise to adverse effects for the functions or performances of hard disk drives and semiconductor devices and the like.

In order to avoid the above mentioned disadvantages which may be caused by the silicone compound, there is a demand for a release sheet containing substantially no silicone compound, that is, a substantially silicone-free release sheet. However, when such a substantially silicon-free release sheet is used in combination with an acrylic pressure sensitive adhesive, a required release force when the release sheet is peeled off from the pressure sensitive adhesive sheet becomes large as about twice as that required in the case where a release sheet having a releasing agent layer made of a silicone resin is used. In other words, such a silicone-free release sheet involves problems in that not only releasability of the release sheet from the pressure sensitive adhesive sheet becomes lowered but also removability of the pressure sensitive adhesive sheet from an adherend also becomes lowered.

### SUMMARY OF THE INVENTION

It is therefore an object of the present invention to provide a pressure sensitive adhesive article which hardly gives such adverse effects due to the silicone compound as described above and which has an improved releasability that makes it possible to peel off a release sheet with a small release force at a boundary between a releasing agent layer of the release sheet and a pressure sensitive adhesive layer.

In order to achieve the above mentioned object, the present invention is directed to a pressure sensitive adhesive article which comprises a pressure sensitive adhesive layer mainly formed of polyurethane resin; and a releasing agent layer mainly formed of polyolefin resin, which is adhered to the pressure sensitive adhesive layer, wherein wetting tension at the surface of the releasing agent layer which faces the pressure sensitive adhesive layer measured according to the wetting tension test defined by JIS K 6768 is equal to or less than 33 mN/m.

Further, another aspect of the present invention is directed to a pressure sensitive adhesive article which comprises a pressure sensitive adhesive layer mainly formed of polyurethane resin; and a releasing agent layer mainly formed of polyolefin resin having a density of equal to or less than 0.94 g/cm³, which is adhered to the pressure sensitive adhesive layer.

Furthermore, yet another aspect of the present invention is directed to a pressure sensitive adhesive article which comprises a pressure sensitive adhesive layer mainly formed of polyurethane resin; and a releasing agent layer mainly formed of polyolefin resin having a density of equal to or less than 0.94 g/cm³, which is adhered to the pressure sensitive adhesive layer, wherein wetting tension at the surface of the releasing agent layer which faces the pressure sensitive adhesive layer measured according to the wetting tension test defined by JIS K 6768 is equal to or less than 33 mN/m.

In the present invention, the pressure sensitive adhesive article may be a pressure sensitive adhesive sheet with a release sheet. The pressure sensitive adhesive sheet with a release sheet may comprise a pressure sensitive adhesive sheet including a base material on which the pressure sensitive adhesive layer is provided, and a release sheet including a release sheet base material on which the releasing agent layer is provided, the release sheet being removably attached to the pressure sensitive adhesive layer of the pressure sensitive adhesive sheet through the releasing agent layer thereof.

In this case, even if the pressure sensitive adhesive sheet having the pressure sensitive adhesive layer contains silicone compound, it is preferred that the content thereof is 500 g/m² or less.

Further, it is also preferred that when the pressure sensitive adhesive sheet is used after it has been peeled off from the release sheet, the pressure sensitive adhesive sheet may generate a gas at a temperature of 85° C. for 30 minutes, but the amount of the gas generated from the pressure sensitive adhesive sheet is equal to or less than 20 mg/m².

Furthermore, it is also preferred that when the pressure sensitive adhesive sheet is used after it has been peeled off from the release sheet, the pressure sensitive adhesive sheet contains ions of NOₓ⁻, Cl⁻, PO₄³⁻, F⁻, K⁺, Na⁺ and Ca²⁺, but the sum of amounts of these ions is equal to or less than 20 mg/m².

Furthermore, it is also preferred that the base material of the pressure sensitive adhesive sheet is formed from a plastic film or a lint-free paper.

Moreover, it is also preferred that the pressure sensitive adhesive sheet further comprises at least one antistatic layer provided on one or both of the surfaces of the base material.

In the present invention, the pressure sensitive adhesive article may be a pressure sensitive adhesive tape. The pressure sensitive adhesive tape may comprise a base material having both surfaces, the pressure sensitive adhesive layer provided on one of the surfaces of the base material and the releasing agent layer provided on the other surface of the base material, wherein the pressure sensitive adhesive tape being wound in a roll form until it is used.

In this case, even if the pressure sensitive adhesive tape having the pressure sensitive adhesive layer contains silicone compound, it is preferred that the content thereof is 500 g/m² or less.

Further, it is also preferred that when the pressure sensitive adhesive tape is used, the pressure sensitive adhesive tape may generate a gas at a temperature of 85° C. for 30 minutes, but the amount of the gas generated from the pressure sensitive adhesive tape is equal to or less than 20 mg/m².

Furthermore, it is also preferred that when the pressure sensitive adhesive tape is used, the pressure sensitive adhesive tape contains ions of NOₓ⁻, Cl⁻, PO₄³⁻, F⁻, K⁺, Na⁺ and Ca²⁺, but the sum of amounts of these ions is equal to or less than 20 mg/m².

Furthermore, it is also preferred that the base material of the pressure sensitive adhesive tape is formed from a plastic film or a lint-free paper.

Moreover, it is also preferred that the pressure sensitive adhesive tape further comprises at least one antistatic layer provided on one or both of the surfaces of the base material.

These and other objects, structures, and advantages of the present invention will be more apparent when the following detailed description of the present invention are considered taken in conjunction with the appended drawings.

### BRIEF DESCRIPTION OF THE DRAWINGS

FIG. 1 is a schematic cross-sectional view of a first embodiment of a pressure sensitive adhesive article according to the present invention;

FIG. 2 is a schematic cross-sectional view of a second embodiment of a pressure sensitive adhesive article according to the present invention; and

FIG. 3 is a schematic cross-sectional view of a third embodiment of a pressure sensitive adhesive article according to the present invention.

### DETAILED DESCRIPTION OF THE INVENTION

Hereinbelow, a detailed description will be made with regard to preferred embodiments of a pressure sensitive adhesive article according to the present invention.

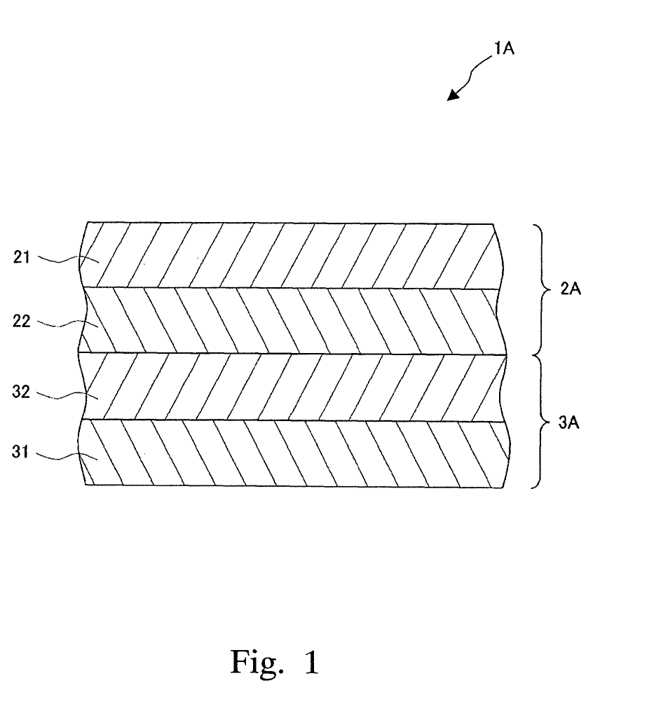

FIG. 1 is a schematic cross-sectional view which shows a first embodiment of the pressure sensitive adhesive article of the present invention. As shown in FIG. 1, a pressure sensitive adhesive article 1A of the present invention is formed into a pressure sensitive adhesive sheet with a release sheet which comprises a pressure sensitive adhesive sheet 2A composed from a base material 21 and a pressure sensitive adhesive layer 22 provided on one surface of the base material 21 and a release sheet 3A composed from a release sheet base material 31 and a releasing agent layer 32 provided on one surface of the release sheet base material 31, wherein the pressure sensitive adhesive layer 22 is in contact with the releasing agent layer 32 so that the pressure sensitive adhesive sheet 2A can be peeled off or removed from the release sheet 3A.

In the pressure sensitive adhesive article of the present invention, the releasing agent layer is mainly constituted of polyolefin resin, as will be described later in detail. Therefore, use of the pressure sensitive adhesive article of the present invention makes it possible to effectively prevent the occurrence of the above-described adverse effects caused by silicone compound.

The practical application of the pressure sensitive adhesive article of the present invention is not particularly limited, but it is preferably used for adherends susceptible to adverse effects by silicone compound because of the advantage described above. By using the pressure sensitive adhesive article of the present invention for such adherends, the effect obtained by the present invention becomes more conspicuous.

For example, the present invention can be applied to a pressure sensitive adhesive article or the like which is adapted to be attached to electronic equipment or electronic components such as hard disk drives (HDD), semiconductor devices, relays and the like, or semiconductor manufacturing equipment used in various manufacturing processes of semiconductor devices or associated items thereof. This is because in such uses, it is necessary to prevent contamination by silicone compound.

The pressure sensitive adhesive article of the present invention can be used in a state that the pressure sensitive adhesive layer thereof is attached to semiconductor manufacturing equipment used in various manufacturing processes of semiconductor devices or associated items thereof. Examples of the semiconductor manufacturing equipment include an apparatus for cutting and polishing an ingot of single-crystal silicon, a stepper, a tape remover, a wafer mounter, a wafer control system, a tape laminator, an ultraviolet ray irradiation apparatus, a transportation system, a box or case for temporarily accommodating wafers during an interval between the manufacturing processes, and the like. In this connection, please note that the pressure sensitive adhesive article of the present invention is not limited to one that is intended to be directly attached to the inside or outside of the semiconductor manufacturing equipment.

Further, the pressure sensitive adhesive article of the present invention can also be used for associated items of the semiconductor manufacturing equipment as described above. Examples of the associated items include various items that may exert some influences on the manufacturing line of semiconductor devices, such as consumable items used in the semiconductor manufacturing equipment and packages used for the consumable items, covers of the semiconductor manufacturing equipment, inspection equipment, air conditioners, and the like.

Further, in the pressure sensitive adhesive article of the present invention, the pressure sensitive adhesive layer is mainly constituted of polyurethane resin, as will be described later in detail.

The pressure sensitive adhesive article 1A of the present invention can be used for various adherends. However, for the purpose of only clarification, hereinafter, an explanation will be given to the case where the adherend to which the pressure sensitive adhesive article of the present invention is used is semiconductor manufacturing equipment used in various manufacturing processes of semiconductor devices or an associated item thereof (hereinbelow, generically referred to as “semiconductor manufacturing equipment or the like”).

In the pressure sensitive adhesive article (pressure sensitive adhesive sheet with a release sheet) 1A, the release sheet 3A can be peeled off from the pressure sensitive adhesive sheet 2A, and after peeling-off, the pressure sensitive adhesive sheet 2A is attached to the adherend, that is the semiconductor manufacturing equipment or the like.

Hereinafter, a description will be made with regard to the pressure sensitive adhesive sheet 2A. The pressure sensitive adhesive sheet 2A has a structure in which the pressure sensitive adhesive layer 22 is formed on the base material 21 of the pressure sensitive adhesive sheet 2A.

The base material 21 of the pressure sensitive adhesive sheet 2A has the function to support the pressure sensitive adhesive layer 22, and is constituted from, for example, a plastic film such as polyester film (e.g., polyethylene terephthalate film, polybutylene terephthalate film, or the like), polyolefin film (e.g., polypropylene film, polymethylpentene film, or the like), polycarbonate film, or the like; a metal foil made of aluminum or stainless steel; paper such as glassine paper, woodfree paper, coated paper, impregnated paper, synthetic paper, so-called lint-free paper; or a laminate body of two or more of those materials.

Among these materials, it is particularly preferable that the base material 21 of the pressure sensitive adhesive sheet 2A is constituted from the plastic film such as polyester film (e.g., polyethylene terephthalate film, polybutylene terephthalate film, or the like), or polypropylene film; or lint-free paper from which less particles are generated (see JP-B-H06-11959, for example). When the base material 21 of the pressure sensitive adhesive sheet 2A is constituted from the plastic film or lint-free paper, particles and the like are hard to generate when processing or using. As a result, such a base material 21 of the pressure sensitive adhesive sheet 2A is hard to give adverse effects to semiconductor devices to be manufactured and used. Further, when the base material 21 of the pressure sensitive adhesive sheet 2A is constituted from the plastic film or lint-free paper, cutting, punching or the like during the processing of the pressure sensitive adhesive article becomes easy.

Further, in the case where the plastic film is used as the base material 21 of the pressure sensitive adhesive sheet 2A, it is more preferable that such a plastic film is a polyethylene terephthalate film or a polypropylene film. Among them, a polyethylene terephthalate film is particularly preferable, because it has the advantages in that generation of particles is low and generation of gas when heating is also low.

The thickness of the base material 21 of the pressure sensitive adhesive sheet 2A is not limited to any specific value, but is preferably in the range of 5 to 200 μm, and more preferably in the range of 20 to 100 μm.

Printing or typing may be made to the surface of the base material 21 of the pressure sensitive adhesive sheet 2A (surface opposite to the surface on which the pressure sensitive adhesive layer 22 is formed). Further, surface treatment may be made to the surface of the base material 21 of the pressure sensitive adhesive sheet 2A for the purpose of improving adhesion of printing or typing (not shown in the drawings). Furthermore, the pressure sensitive adhesive sheet 2A may be used as a label.

The pressure sensitive adhesive layer 22 is constituted of a pressure sensitive adhesive composition containing a pressure sensitive adhesive as a main ingredient.

In the present invention, a urethane-based adhesive is mainly used as a pressure sensitive adhesive constituting the pressure sensitive adhesive layer 22.

Meanwhile, in the conventional pressure sensitive adhesive article, an acrylic adhesive as described above has been generally and widely used as a pressure sensitive adhesive. However, in a case where such an acrylic adhesive is used as a pressure sensitive adhesive, if a releasing agent is constituted of a material other than silicone resin, a release sheet can not be smoothly peeled off (that is, required release force is large). In this connection, in a case where the pressure sensitive adhesive article is a pressure sensitive adhesive sheet with a release sheet (that is a label with a release sheet), desired release force is 200 mN/50 mm or less, and 150 mN/50 mm or less is more preferable. Conventionally, in order to achieve such relatively small release force, it was necessarily required to use silicone resin as a releasing agent.

However, use of silicone resin as a releasing agent causes a problem of contamination by silicone compound or the like as described above. Further, it is desirable that the release sheet can be more easily peeled off in a case where a thinner base material of the label is used or a labeling machine is used.

Furthermore, in a case where an acrylic adhesive is used, there is a problem in that a part of the acrylic adhesive remains on an adherend when the pressure sensitive adhesive sheet is peeled off from the adherend. In order to solve the problem, an attempt has been made to increase the cohesive strength of the pressure sensitive adhesive by increasing the amount of a crosslinking agent, but this results in lowered adhesive force. Such a problem arises in most of acrylic adhesives in a case where the adhesive force thereof is in the range of about 8 to 15 N/25 mm (such adhesive force is a middle level).

The present inventors have conducted extensive research, and as a result found that these problems can be solved by using a urethane-based adhesive instead of the acrylic adhesive. That is, by forming the pressure sensitive adhesive layer 22 using a urethane-based adhesive as a main ingredient, it is possible for the pressure sensitive adhesive layer 22 to have sufficient adhesive force and excellent removability.

As for such a urethane-based adhesive, polyurethane resin, polyurethane-urea resin, or the like can be used.

A preferred example of the polyurethane resin includes a resin obtained by reacting polyol with polyisocyanate to synthesize a urethane prepolymer and then adding amine compound or the like to the urethane prepolymer by addition reaction.

Among polyols, polyester polyol, polyether polyol or the like which has two or more of functional groups is preferable. Further, the molecular weight of the polyol to be used is in the range of 1,000 to 5,000, and 1,500 to 3,500 is more preferable. If the molecular weight of the polyol is 1,000 or less, reactivity becomes excessively high so that an obtained urethane prepolymer is liable to gelate. On the other hand, if the molecular weight of the polyol is 5,000 or more, reactivity is lowered. Such polyols may be used singly or in combination of two or more.

Examples of the polyisocyanate include aromatic polyisocyanate, aliphatic polyisocyanate, aromatic-aliphatic polyisocyanate, alicyclic polyisocyanate, and the like. Such polyisocyanates may also be used singly or in combination of two or more.

The polyol and the polyisocyanate should be compounded such that the mole equivalent of isocyanate group of the polyisocyanate with respect to one mole equivalent of active hydrogen of the polyol that can react with isocyanate group is larger than 1 so that the terminal group of the obtained urethane prepolymer is isocyanate group. A proper compounding ratio between the polyol and the polyisocyanate greatly varies depending on the reactivity of the compound, the existing ratio of trivalent or higher valent compound, the purpose of use of an obtained resin, and the like. The equivalent ratio of isocyanate group with respect to active hydrogen group contained in hydroxyl group or functional group that can react with isocyanate group when synthesizing a urethane prepolymer having isocyanate groups at both ends thereof is preferably in the range of 1.01 to 4.00, and more preferably in the range of 1.40 to 3.00.

Specifically, the amount of the polyisocyanate to be compounded with respect to 100 parts by weight of the polyol is preferably in the range of 1 to 30 parts by weight. By setting the amount of the polyisocyanate to be compounded with respect to 100 parts by weight of the polyol to the above range, it is possible to obtain especially excellent cohesive strength and adhesive force. If the amount of the polyisocyanate to be compounded with respect to 100 parts by weight of the polyol is less than 1 part by weight, there is a possibility that cohesive strength is lowered. On the other hand, if the amount of the polyisocyanate to be compounded with respect to 100 parts by weight of the polyol is more than 30 parts by weight, there is a possibility that adhesive force is lowered. Further, it is more preferred that the amount of the polyisocyanate to be compounded with respect to 100 parts by weight of the polyol is in the range of 10 to 20 parts by weight. By setting the amount of the polyisocyanate to the above range, the effect described above becomes more conspicuous.

A catalyst used in synthesizing a urethane prepolymer in the present invention is not limited to any specific one, but tertiary amine compounds, organometallic compounds, and the like can be mentioned, for example. Specifically, dibutyltin dilaurate, tin 2-ethylhexanoate, and the like are preferably used in the light of reactivity and hygienic reasons. These catalysts may be used singly or in combination of two or more.

As for a solvent used in synthesizing a urethane prepolymer in the present invention, a known solvent can be used.

A reaction for obtaining a urethane prepolymer by reacting polyol with polyisocyanate can be carried out by various methods.

Next, amine compound or the like is added to the thus obtained urethane prepolymer by addition reaction to obtain polyurethane-urea resin.

At that time, the compounding ratio between the urethane prepolymer and the amine compound (and polyamine, as necessary) is not limited to any specific value, and is appropriately set according to the purpose of use and target performances.

Further, it is possible to add unsaturated compound to the urethane-based adhesive used in the present invention to cause denaturation, as required.

For example, such unsaturated compound is used for denaturing polyurethane-urea resin. The kind of the unsaturated compound can be appropriately selected according to the purpose of denaturation of the polyurethane-urea resin.

Further, the pressure sensitive adhesive used in the present invention may contain acrylic resin, polyester resin, amino resin, epoxy resin and the like in addition to the polyurethane resin, as required. Furthermore, the pressure sensitive adhesive used in the present invention may contain various additives such as tackifiers, fillers (e.g., talc, calcium carbonate, titanium oxide or the like), coloring agents, ultraviolet absorbers, antioxidants, antifoaming agents, light stabilizers, or the like according to the purpose of use.

On the other hand, urethane acrylate-based oligomer may be used in place of the polyurethane resin. Urethane acrylate-based oligomer is a thermosetting compound and/or an ultraviolet ray curable compound which has at least two carbon-carbon double bonds. Such urethane acrylate-based oligomer can be obtained by reacting isocyanate-terminated urethane prepolymer with acrylate or methacrylate having hydroxyl group (e.g., 2-hydroxyethyl acrylate), in which the isocyanate-terminated urethane prepolymer is prepared by reacting polyester type or polyether type polyol compound with polyisocyanate compound (e.g., 2,4-tolylene diisocyanate).

In a case where such urethane acrylate-based oligomer is employed, the molecular weight thereof is preferably in the range of 300 to 30,000, and more preferably in the range of 1,000 to 8,000. When the pressure sensitive adhesive layer is constituted of urethane acrylate-based oligomer having a molecular weight within the above range, a pressure sensitive adhesive sheet having especially excellent removability can be obtained.

The pressure sensitive adhesive composition may be either of a crosslinked type to which crosslinking treatment has been applied, or a non-crosslinked type to which crosslinking treatment has not been applied. However, the crosslinked type is more preferable. When the crosslinked type is used, a pressure sensitive adhesive layer 22 having more excellent cohesive strength can be formed. Examples of a crosslinking agent that can be used for the crosslinked type pressure sensitive adhesive composition include epoxy-based compounds, isocyanate compounds, metal chelate compounds, metal alkoxides, metal salts, amine compounds, hydrazine compounds, aldehyde compounds, and the like.

If necessary, the pressure sensitive adhesive composition used in the present invention may contain various additives such as antistatic agents, plasticizers, tackifiers, stabilizers, and the like.

The thickness of the pressure sensitive adhesive layer 22 is not limited to any specific value, but is preferably in the range of 5 to 100 μm. With such a thickness, good adhesive force can be obtained.

In such a pressure sensitive adhesive sheet 2A, it is preferred that the content of silicone compound that may be contained in the pressure sensitive adhesive sheet 2A is 500 μg/m² or less.

Examples of the silicone compound include low molecular weight silicone resins, silicone oils, siloxanes and the like.

If the content of silicone compound in the pressure sensitive adhesive sheet 2A is 500 μg/m² or less, an amount of silicone compound that may be discharged from the pressure sensitive adhesive sheet 2A can be minimized so as to be able to ignore it when the pressure sensitive adhesive sheet 2A is attached to an adherend, so that it is possible to effectively prevent the occurrence of the above-described adverse effects caused by silicone compound. That is, by using the pressure sensitive adhesive article of the present invention, it is possible to prevent the phenomenon that silicone compound is discharged from the pressure sensitive adhesive sheet so that such silicone compound adheres and deposits on the surface of a semiconductor device to be manufactured or the like as much as possible.

Further, in manufacturing and assembling processes of electronic equipment or electronic components such as hard disk drives (HDD), semiconductor devices, relays and the like, there are some processes in which environmental temperature at the manufacturing line becomes high. Further, in the manufactured products such as semiconductor devices, there are cases that their temperatures are raised due to heat generated by parts thereof. In a case where the conventional pressure sensitive adhesive sheet is used in such condition, the amount of silicone compound discharged therefrom tends to be large due to such high temperature. On the other hand, in the case of the pressure sensitive adhesive article of the present invention (that is, the pressure sensitive adhesive sheet of the pressure sensitive adhesive article), the amount of silicone compound discharged therefrom is very small. Therefore, it is possible to effectively prevent the phenomenon that silicone compound deposits on the surface of a semiconductor device to be manufactured. As a result, troubles will hardly occur in the manufactured semiconductor device, and therefore reliability of the semiconductor device is improved.

Such an effect becomes conspicuous when the content of silicone compound in the pressure sensitive adhesive sheet 2A is 100 μg/m² or less.

Further, when the pressure sensitive adhesive sheet 2A_is used under high temperature, there is a case that a gas is generated therefrom. However, no problem will arise if the amount of gas generated is negligibly small. For example, practically, it is preferred that the amount of gas generated at a temperature of 85° C. and for 30 minutes is 20 mg/m² or less, and more preferably 5 mg/m² or less. Such a gas is usually generated from any component of the pressure sensitive adhesive sheet 2A. Examples of the component include unreacted monomers or low molecular weight polymers among resin components of the pressure sensitive adhesive, such as (meth)acrylic acid, (meth)acrylic acid ester or styrene; solvents such as toluene, ethyl acetate, methyl ethyl ketone; and plasticizers such as phthalate ester(dioctyl phthalate, diethylhexyl phthalate, or di-n-decyl phthalate). If the amount of gas generated from the pressure sensitive adhesive sheet 2A is decreased, substances to be adhered to and deposited on the surface of a semiconductor device to be manufactured can be decreased. In this regard, the amount of gas generated from the pressure sensitive adhesive sheet 2A tends to increase as environmental temperature of the pressure sensitive adhesive sheet 2A becomes high. In semiconductor manufacturing equipment or the like, there is a case that a temperature inside the equipment elevates during operation. In such a case, however, it is considered that the environmental temperature of the pressure sensitive adhesive sheet 2A is generally 80° C. or lower. Therefore, if the amount of gas generated at a temperature of 85° C. and for 30 minutes is a value equal to or lower than the above-mentioned value, the amount of gas generated from the pressure sensitive adhesive sheet 2A is further decreased under the ordinary use conditions of semiconductor manufacturing equipment or the like, so that the pressure sensitive adhesive sheet 2A can be suitably used for the semiconductor manufacturing equipment or the like in the light of gas generation.

Further, in the pressure sensitive adhesive sheet 2A, the sum of amounts of ions of NOₓ⁻, Cl⁻, PO₄³⁻, F⁻, K⁺, Na⁺ and ca²⁺ is preferably 20 mg/m² or less, and more preferably 5 mg/m² or less. If the pressure sensitive adhesive sheet 2A contains a large amount of such ions, there is a case that such ions adhere to a semiconductor device to be manufactured, thereby giving adverse effects to the semiconductor devices. Contrary to this, when the amount of such ions is decreased to the above-mentioned value or less, an amount of ions generated from the pressure sensitive adhesive sheet 2A can be extremely decreased, and as a result, a semiconductor device to be manufactured or the like is hard to receive such adverse effects.

Normally, the release sheet 3A is being adhered to the pressure sensitive adhesive sheet 2A until it is used. The above-mentioned characteristics of the pressure sensitive adhesive sheet 2A and the pressure sensitive adhesive layer 22 depend on the release sheet 3A, and in particular greatly depend on components and properties of the releasing agent layer 32. In order for the pressure sensitive adhesive sheet 2A and the pressure sensitive adhesive layer 22 to have the above-mentioned characteristics, the release sheet 3A is preferably formed as follows.

The release sheet 3A has a structure in which the releasing agent layer 32 is formed on the release sheet base material 31.

The material of the release sheet base material 31 is the same as that of the base material 21 of the pressure sensitive adhesive sheet 2A mentioned above.

The thickness of the release sheet base material 31 is not limited to any specific value, but is preferably in the range of 5 to 200 μm, and more preferably in the range of 20 to 100 μm.

The releasing agent layer 32 is mainly constituted of polyolefin resin.

Examples of polyolefin resins include polyethylene resins; polypropylene resins; olefin-based thermoplastic elastomers such as ethylene a-olefin copolymers; and mixtures of these materials.

In a case where the releasing agent layer 32 is constituted of polypropylene resin, the releasing agent layer 32 may be formed into a laminate structure by extrusion laminating, which is laminated on paper or film, or may be formed into a film of CPP or OPP. In such cases, the shape or form of the releasing agent layer 32 is not particularly limited, and such a releasing agent layer can be used as long as it has a desired release force.

Further, in a case where the releasing agent layer 32 is constituted of olefin-based thermoplastic elastomers such as ethylene α-olefin copolymers (ethylene-propylene, ethylene-butene, or the like) or ethylene higher α-olefin copolymers (ethylene-octene, or the like), the releasing agent layer 32 may be formed into a laminate structure by extrusion laminating, which is laminated on paper or film, or the releasing agent layer 32 may be formed by coating. In such cases, the shape or form of the releasing agent layer 32 is not particularly limited, and such a releasing agent layer can be used as long as it has a desired release force.

Among these materials, polyethylene resins and/or olefin-based thermoplastic elastomers are preferably used as a releasing agent constituting the releasing agent layer 32. When the releasing agent layer 32 is constituted of such a releasing agent, it becomes unnecessary for the releasing agent layer 32 to contain any silicone compound that is likely to give adverse effects to a semiconductor device to be manufactured. Therefore, it is possible to prevent an environment in which silicone compound is transferred into the pressure sensitive adhesive layer 22 from the releasing agent layer 32 from being produced in the pressure sensitive adhesive article 1A. Further, when the releasing agent layer 32 is constituted of polyethylene resin and/or olefin-based thermoplastic elastomer, it becomes unnecessary to use any silicone resins when the pressure sensitive adhesive article 1A is produced, and as a result, it becomes possible to prevent the pressure sensitive adhesive article from being contaminated by silicone compound in the production site as much as possible, and thereby it becomes possible to prevent silicone compound from being attached to the surface of the base material 21 of the pressure sensitive adhesive sheet 2A or the release sheet base material 31.

Further, when the releasing agent layer 32 is constituted of olefin-based thermoplastic elastomer and/or polyethylene resin, excellent releasability can be obtained in addition to the above-mentioned effects.

For this reason, when the releasing agent layer 32 is constituted of olefin-based thermoplastic elastomer and/or polyethylene resin, even if the pressure sensitive adhesive article 1A contains silicone compound, the sum of the amounts of silicone compounds contained in the pressure sensitive adhesive article IA can be decreased to 500 μg/m² or less, and preferably to 100 μg/m² or less. This makes it possible to prevent deposition or adhesion of silicone compounds on a semiconductor device to be manufactured when the pressure sensitive adhesive sheet 2A is attached to the semiconductor manufacturing equipment or the like. In addition, the pressure sensitive adhesive sheet 2A can be easily and securely peeled off from the release sheet 3A.

Further, in a case where the releasing agent layer 32 is constituted of olefin-based thermoplastic elastomer and/or polyethylene resin, it is preferred that the olefin-based thermoplastic elastomer satisfies the following condition.

Examples of the olefin-based thermoplastic elastomer include ethylene-propylene copolymer, ethylene-octene copolymer, or the like. Among them, ethylene-propylene copolymer is particularly preferable. By using the ethylene-propylene copolymer as the olefin-based thermoplastic elastomer, a release sheet 3A having particularly excellent releasability can be obtained. As for commercially available ethylene-propylene copolymer, TAFMER series (products of Mitsui Chemical Corporation) can be mentioned.

In the present invention, the releasing agent layer 32 should satisfy at least one of the following conditions <1> and <2>. This makes it possible for the release sheet 3A to have sufficient releasability.

<1> The releasing agent layer 32 is mainly constituted of polyolefin resin having a density of 0.94 g/cm³ or less.

In particular, in the case where olefin-based thermoplastic elastomer is used, the density thereof is preferably in the range of 0.80 to 0.90 g/cm³, and more preferably in the range of 0.86 to 0.88 g/cm³. If the density of the olefin-based thermoplastic elastomer is less than the above lower limit value, heat resistance tends to lower. On the other hand, if the density of the olefin-based thermoplastic elastomer exceeds the above upper limit value, release force becomes large.

On the other hand, in the case where polyethylene resin is used, the density thereof is preferably in the range of 0.890 to 0.925 g/cm³, and more preferably in the range of 0.900 to 0.922 g/cm³. If the density of the polyethylene resin is less than the above lower limit value, heat resistance tends to lower. On the other hand, if the density of the polyethylene resin exceeds the above upper limit value, release force becomes large.

Preferably, such polyethylene resin is synthesized using a transition metal catalyst such as Ziegler Natta catalyst, metallocene catalyst, or the like. In particular, polyethylene resin synthesized using metallocene catalyst has excellent releasability and heat resistance.

<2> The wetting tension at the surface of the releasing agent layer 32 which faces the pressure sensitive adhesive layer 22 measured according to JIS K 6768 is 33 mN/m or less.

The wetting tension is adjusted by changing manufacturing conditions of the releasing agent layer 32,such as a temperature when applying the releasing agent onto the release sheet base material 31.

As described above, the present invention should satisfy at least one of the conditions <1> and <2>, but it is preferred that the present invention satisfies both of the conditions <1> and <2>. As a result, the effect described above becomes more conspicuous.

Further, the number average molecular weight of the polyolefin-based resin determined according to a GPC method is preferably in the range of 15,000 to 500,000. If the molecular weight thereof is too small, there is a case that the physical strength of the surface of the releasing agent layer 32 to which the pressure sensitive adhesive layer is adhered is decreased, and the releasing agent layer 32 is come off from the release sheet base material 31 when the release sheet is folded because of an increased crystallinity of the resin. On the other hand, if the molecular weight thereof is too large, the fluidity of the resin at low temperature becomes poor so that processability during extrusion processing is lowered. In such a case, there are possibilities that an extrusion mold is damaged because of an increased back pressure, and a desired processing speed can not be obtained because of a reduced amount of the resin extruded. Further, some gaps are likely to be produced in the releasing agent layer.

Further, the releasing agent layer 32 may contain other resin components or various additives such as plasticizers, stabilizers, or the like.

The thickness of the releasing agent layer 32 is not limited to any specific value, but is preferably in the range of 5 to 50 μm, and more preferably in the range of 10 to 30 μm. If the thickness of the releasing agent layer 32 is less than the above lower limit value, releasability tends to lower. On the other hand, if the thickness of the releasing agent layer 32 exceeds the above upper limit value, it becomes difficult to further improve releasability, which is not economical.

The pressure sensitive adhesive article (pressure sensitive adhesive sheet with a release sheet) 1A is constituted from the pressure sensitive adhesive sheet 2A and,the release sheet 3A described above.

As described above, even if the pressure sensitive adhesive sheet of the pressure sensitive adhesive article 1A contains silicone compound, it is preferred that the content thereof is 500 μg/m² or less. In this case, examples of the silicone compound include low molecular weight silicone resins, silicone oils, siloxanes, and the like.

Further, in such a pressure sensitive adhesive article 1A, the count of generated particles having a diameter of 0.1 μm or more is preferably 100 particles/liter or less, and more preferably 20 particles/liter or less. When the count of generated particles is equal to or less than this value, it is possible to suitably prevent dusts or particles which are liable to give adverse effects to a semiconductor device to be manufactured from being generated from the pressure sensitive adhesive sheet 2A.

Next, a description will be made with regard to the production method of the pressure sensitive adhesive article 1A of the present invention having a structure described above.

For example, a release sheet base material 31 is prepared, and then a releasing agent is applied onto the release sheet base material 31 to form a releasing agent layer 32, to thereby obtain a release sheet 3A. Examples of the method for applying the releasing agent onto the release sheet base material 31 include an extrusion laminating method and the like.

In this case, by changing a temperature when applying the releasing agent, or the like, it is possible to adjust a wetting tension at the surface of the releasing agent layer 32 that faces the pressure sensitive adhesive layer 22. For example, a temperature at the time when a releasing agent mainly composed of polyolefin resin is applied onto the release sheet base material 31 by extrusion laminating is preferably 270° C. or lower. If the extrusion laminating is carried out at high temperature over 270° C., adhesion between the releasing agent and the release sheet base material is improved, but on the other hand, a wetting tension at the surface of the releasing agent layer 32 that faces the pressure sensitive adhesive layer 22 is increased due to oxidation of the surface of the releasing agent layer 32 to which the pressure sensitive adhesive layer 22 is to be adhered. As a result, release force when the pressure sensitive adhesive sheet is peeled off from the release sheet is increased.

Next, a base material 21 of the pressure sensitive adhesive sheet 2A is prepared, and then a pressure sensitive adhesive composition is applied onto the base material 21 of the pressure sensitive adhesive sheet 2A to form a pressure sensitive adhesive layer 22, thereby obtaining a pressure sensitive adhesive sheet 2A. Examples of the method for applying the pressure sensitive adhesive composition onto the-base material 21 of the pressure sensitive adhesive sheet 2A include knife coating, blade coating, roll coating, die coating and the like. The pressure sensitive adhesive composition used in these methods may be a solvent type, an emulsion type or a hot melt type or the like.

Thereafter, the release sheet 3A is laminated onto the thus obtained pressure sensitive adhesive sheet 2A such that the pressure sensitive adhesive layer 22 contacts the releasing agent layer 32, so that a pressure sensitive adhesive article IA can be obtained.

According to such a production method, a pressure sensitive adhesive article 1A can be produced without exposing the release sheet 3A to high temperature in the course of the production. Further, the releasing agent layer 32 is hard to receive influence of a solvent which is used in forming the pressure sensitive adhesive layer 22.

The pressure sensitive adhesive article IA may be produced by forming a pressure sensitive adhesive layer 22 on the releasing agent layer 32 of the release sheet 3A and then superposing a base material 21 of the pressure sensitive adhesive sheet 2A onto the pressure sensitive adhesive layer 22.

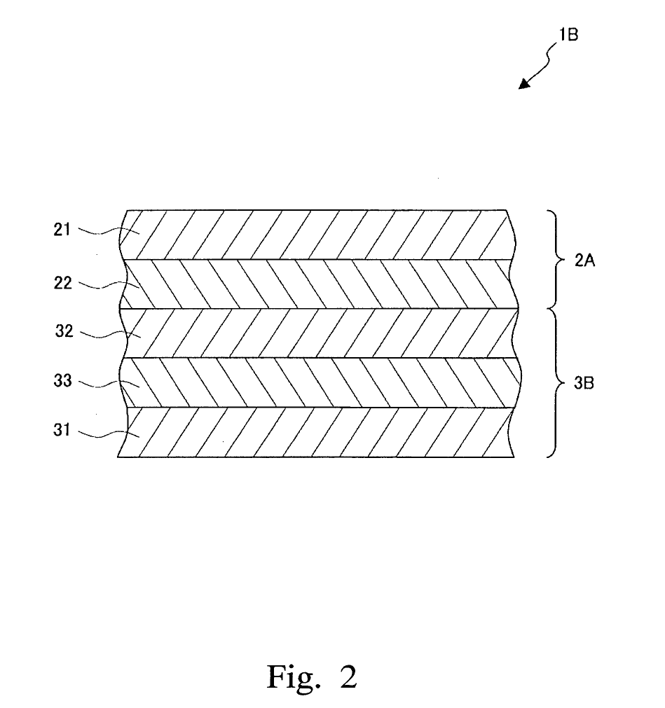

FIG. 2 is a schematic cross-sectional view which shows a second embodiment of the pressure sensitive adhesive article 1B of the present invention. In the following, the pressure sensitive adhesive article 1B of the second embodiment will be explained by focusing the differences between the first and second embodiments, and explanation with regard to the overlapping points is omitted.

As shown in FIG. 2, in the pressure sensitive adhesive article 1B of this embodiment, the releasing agent layer 32 is formed on the release sheet base material 31 through an adhesion enhancing layer 33 as an intermediate layer. That is, in this embodiment, the release sheet 3B has a structure in which the adhesion enhancing layer 33 is provided between the release sheet base material 31 and the releasing agent layer 32.

According to this structure, adhesiveness between the release sheet base material 31 and the releasing agent layer 32 is improved. As a result, it is possible to prevent delamination from occurring at the interface between the release sheet base material 31 and the releasing agent layer 32 when peeling off the release sheet 3B from the pressure sensitive adhesive sheet 2A. Further, it is also possible to prevent a part of the releasing agent layer 32 from adhering to or remaining on the pressure sensitive adhesive layer 22 after the release sheet 3B has been peeled off.

As for a material constituting the adhesion enhancing layer 33, polyethylene resins can be mentioned, for example.

The thickness of the adhesion enhancing layer 33 is not particularly limited, but is preferably in the range of 5 to 50 μm, and more preferably in the range of 10 to 30 μm.

Hereinbelow, a description will be made with regard to a production method of the release sheet 3B of this embodiment.

For example, a release sheet 3B can be obtained by preparing a release sheet base material 31, applying a constituent material of the adhesion enhancing layer 33 onto this release sheet base material 31 to form an adhesion enhancing layer 33, and then applying a releasing agent onto the adhesion enhancing layer 33 to form a releasing agent layer 32. As for the method of applying the constituent material of the adhesion enhancing layer 33 onto the release sheet base material 31, an extrusion laminating method can be mentioned. In this case, the adhesion enhancing layer 33 and the releasing agent layer 32 may be laminated on the release sheet base material 31 in this order by the extrusion laminating method, or those layers may be simultaneously laminated on the release sheet base material 31 by a coextrusion lamination method.

In this embodiment, the intermediate layer is the adhesion enhancing layer 33 that increases adhesive strength between the release sheet base material 31 and the releasing agent layer 32, but the intermediate layer may have purposes other than this. For example, the intermediate layer may be a barrier layer that prevents transfer of the components between the releasing agent layer and the release sheet base material. Further, the release sheet may have two or more intermediate layers.

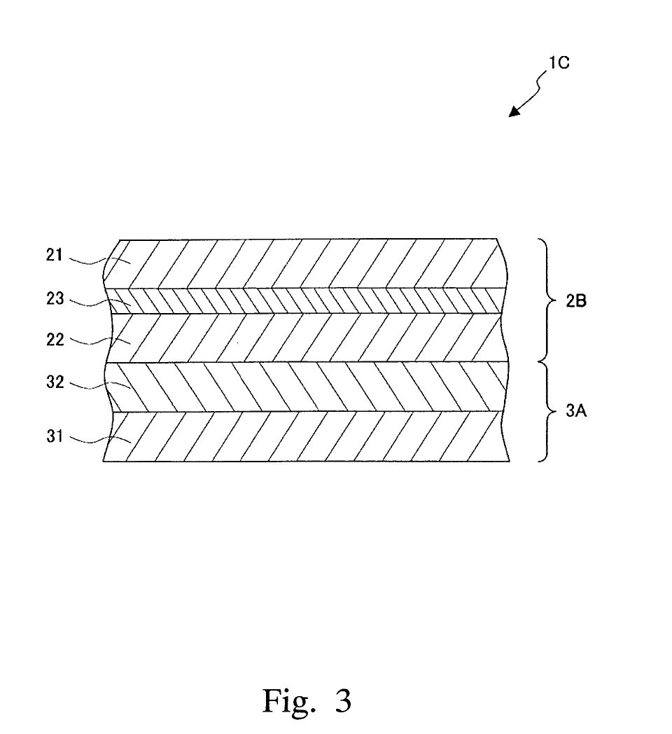

FIG. 3 is a schematic cross-sectional view which shows a third embodiment of the pressure sensitive adhesive article 1C of the present invention. In the following, the pressure sensitive adhesive article 1C of the third embodiment will be explained by focusing the differences from the first and second embodiments, and explanation with regard to the overlapping points is omitted.

As shown in FIG. 3, in the pressure sensitive adhesive article 1C of this embodiment, the pressure sensitive adhesive sheet 2B has a structure in which an antistatic layer 23 is provided between the base material 21 of the pressure sensitive adhesive sheet 2B and the pressure sensitive adhesive layer 22.

According to this structure, it is possible to effectively prevent electrification from being generated at the time when the pressure sensitive adhesive sheet 2B is peeled off from the release sheet 3A. Further, even in the case that a voltage is generated in the vicinity of an attaching part of the pressure sensitive adhesive sheet 2B, it can be grounded safely. In this regard, it is to be noted that the antistatic layer 23 may be provided on one surface of the base material 21 of the pressure sensitive adhesive sheet 2B that is a surface opposite to the surface on which the pressure sensitive adhesive layer 22 is provided, or may be provided on each of the surfaces of the base material 21 of the pressure sensitive adhesive sheet 2B.

Furthermore, it is preferable that the antistatic layer 23 does not substantially contain ions (nonionic). By using a nonionic antistatic agent, generation of ions from the antistatic agent can be effectively prevented. Thus, transfer of ions to a semiconductor device to be manufactured can be prevented, and as a result, the occurrence of adverse effects on a semiconductor device to be manufactured can be more effectively prevented. Preferable examples of such an antistatic agent include carbon black, metal-based conductive filler, metal oxide-based conductive filler and π electron conjugated conductive polymer.

In this embodiment, the intermediate layer is formed from the antistatic layer 23 that prevents generation of voltage of electrification at peeling-off, but such an intermediate layer may have purposes other than this. For example, the intermediate layer may be a barrier layer that prevents transfer of components between the base material of the pressure sensitive adhesive sheet and the pressure sensitive adhesive layer. Further, the pressure sensitive adhesive sheet may have two or more intermediate layers. For example, the pressure sensitive adhesive sheet may have the above-mentioned antistatic layer and barrier layer as its intermediate layers.

Although the present invention has been described above based on the preferred embodiments, the present invention is not limited thereto.

For example, the pressure sensitive adhesive article of the present invention may have a structure such that two pressure sensitive adhesive layers are formed on both sides of the base material of the pressure sensitive adhesive sheet, and release sheets are respectively attached to each of the pressure sensitive adhesive layers. By using this structure, it is possible to bond different adherends through the pressure sensitive adhesive sheet. In this case, the pressure sensitive adhesive layers provided on both sides of the base material of the pressure sensitive adhesive sheet may have substantially the same thickness, composition and the like, or may have different thickness, composition and the like, respectively.

Further, the form of the pressure sensitive adhesive article of the present invention is not limited to a sheet or label form, and the pressure sensitive adhesive article may be formed into a band form.

Furthermore, in each of the above-described embodiments, the pressure sensitive adhesive article of the present invention is formed into a pressure sensitive adhesive sheet with a release sheet, which is used by removing the release sheet from the pressure sensitive adhesive article and then attaching the pressure sensitive adhesive sheet to an adherend. However, the pressure sensitive adhesive article of the present invention may be a pressure sensitive adhesive article that is intended to be attached to an adherend in a state where the pressure sensitive adhesive layer and the releasing agent layer are being in contact with each other. That is, the pressure sensitive adhesive article of the present invention may be formed into a pressure sensitive adhesive tape in a roll form having no release sheet, in which the pressure sensitive adhesive layer is provided on one surface of the base material and the releasing agent layer is provided on the other surface of the base material.

Furthermore, in each of the embodiments described above, although an explanation has been given using semiconductor manufacturing equipment used in various manufacturing processes of semiconductor devices or associated items thereof (that is, semiconductor manufacturing equipment or the like) as a representative of an adherend, the practical application of the pressure sensitive adhesive article of the present invention is not limited to such uses. The pressure sensitive adhesive article of the present invention can be suitably used as a pressure sensitive adhesive article to be attached to electronic equipment or electronic components such as hard disk drives (HDD), semiconductor devices, relays, and the like, or a pressure sensitive adhesive article to be directly attached to a human body, such as cosmetic sheets, sticking plaster, and the like.

### EXAMPLES

Hereinbelow, a description will be made with regard to actual examples of the pressure sensitive adhesive article of the present invention. The following description will be made based on specific compounds and values, but it goes without saying that the present invention is not limited to these examples.

### Example 1

A urethane-based adhesive was synthesized as follows.

A four-necked flask equipped with a stirrer, a reflux condenser, a nitrogen gas inlet, a thermometer, and a dropping funnel was prepared. Then, 300 g of isophorone diamine, 300 g of toluene, and 0.2 g of copper acetate were put in the flask, and 360 g of ethynylbenzene was then dropped into the flask. After the completion of the dropping, they were reacted at 100° C. for three hours, and 360 g of toluene was then added, to thereby obtain a compound (a).

A four-necked flask equipped with a stirrer, a reflux condenser, a nitrogen gas inlet, a thermometer, and a dropping funnel was prepared. Then, 257 g of polyether polyol “PP-2000” (which is a difunctional polyether polyol having a molecular weight of 2,000 and an OH-value of 56 available from Sanyo Chemical industries, Ltd.), 43 g of isophorone diisocyanate (which is a product of HULS JAPAN), and 75 g of toluene, and 0.05 g of dibutyltin dilaurate as a catalyst were put in the flask. They were heated to 100° C. little by little and reacted for 2 hours. After the determination of the amount of the residual isocyanate group according to titration, the reaction mixture was cooled to 40° C., and then 227 g of ethyl acetate was added. Thereafter, 50 g of the compound (a) was added dropwise over a period of 1 hour, and the thus obtained mixture was then allowed to stand for 1 hour. Then, 2.2 g of 2-amino-2-methyl-propanol (which is a product of NAGASE & Co., Ltd.) was added to terminate the reaction, to thereby obtain a solution of Michael addition type urethane-urea resin. The obtained reaction solution was colorless and transparent, and had a solid content of 50 wt %, a viscosity of 3,000 cps, a number average molecular weight (Mn) of 27,000, and a weight average molecular weight (Mw) of 94,000.

2 g of ethyl acetate solution as a curing agent containing 75% of hexamethylene diisocyanate-trimethylol propane adduct was mixed with 100 g of the synthesized Michael addition type urethane-urea resin solution to prepare a coating agent for pressure sensitive adhesive layer. The coating agent for pressure sensitive adhesive layer was applied onto a polyethylene terephthalate film having a thickness of 50 μm using a knife coater such that the dried weight of the coating agent was 25 g/m². The coating agent applied on the polyethylene terephthalate film was dried using a drier at 110° C. for 1 minute, to thereby prepare a pressure sensitive adhesive sheet.

Further, a release sheet was prepared as follows.

A lint-free paper (“CLEAN PAPER” which is a product of LINTEC Corporation and its thickness was 38 μm) was prepared as a release sheet base material, and an adhesion enhancing layer was formed on one surface of the release sheet base material by the extrusion laminating method. Further, a releasing agent layer (thickness: 15 μm) was formed on the adhesion enhancing layer by the extrusion laminating method, to thereby prepare a release sheet. In this connection, the adhesion enhancing layer was formed from polyethylene (“L-405H” which is a product of Sumitomo Chemical Co., Ltd. and its density is 0.924 g/cm³), and the releasing agent layer was formed from a mixture of 50 parts by weight of olefin-based thermoplastic elastomer containing ethylene-propylene copolymer (“TAFMER P-0280G” which is a product of Mitsui Chemical Corporation, and its density is 0.87 g/cm³) and 50 parts by weight of polyethylene (“J-REX807A” which is a product of Japan Polyolefins Co., Ltd and its density is 0.916 g/cm³). It is to be noted here that a temperature upon laminating (that is, a temperature of a constituent material of the releasing agent layer) was set to 260° C.

By adhering the thus obtained release sheet to the pressure sensitive adhesive sheet, a pressure sensitive adhesive article was produced.

### Example 2

A urethane-based adhesive (“Cyabain ST201” which is a product of TOYO INK MFG. Co., Ltd.) and a curing agent (“T501B” which is a product of TOYO INK MFG. Co., Ltd.) were mixed in a ratio of 100:1 to prepare a coating agent for pressure sensitive adhesive layer. The coating agent for pressure sensitive adhesive layer was applied onto a polyethylene terephthalate film having a thickness of 50 μm using a knife coater such that the dried weight of the coating agent was 25 g/m². The coating agent applied on the polyethylene terephthalate film was dried using a drier at 110° C. for 1 minute, to thereby prepare a pressure sensitive adhesive sheet.

A release sheet was prepared in the same manner as Example 1, and the obtained release sheet was superposed to the pressure sensitive adhesive sheet to produce a pressure sensitive adhesive article.

### Example 3

A pressure sensitive adhesive article was produced in the same manner as Example 2 except that the releasing agent layer was formed from polyethylene having a density of 0.916 g/cm³ (“J-REX JH-807A” which is a product of Japan Polyolefins Co., Ltd.).

### Example 4

A pressure sensitive adhesive article was produced in the same manner as Example 2 except that the releasing agent layer was formed from polyethylene having a density of 0.912 g/cm³ (“EXCELLEN EX CR8002” which is a product of Sumitomo Chemical Co., Ltd.).

### Example 5

A pressure sensitive adhesive article was produced in the same manner as Example 2 except that the releasing agent layer was formed from polyethylene having a density of 0.936 g/cm³ (“J-REX JH-778K” which is a product of Japan Polyolefins Co., Ltd.).

### Example 6

A pressure sensitive adhesive article was produced in the same manner as Example 2 except that the releasing agent layer was formed from polyethylene having a density of 0.948 g/cm³ (“J-REX KM640A” which is a product of Japan Polyolefins Co., Ltd.).

### Example 7

A pressure sensitive adhesive article was produced in the same manner as Example 2 except that the releasing agent layer was formed from polypropylene having a density of 0.890 g/cm³ (“SUN-ALLOMER PHA-03A” which is a product of Sun Allomer Ltd.).

### Example 8

A pressure sensitive adhesive article was produced in the same manner as Example 2 except that the releasing agent layer was formed from ethylene-propylene copolymer having a density of 0.87 g/cm³ (“TAFMER P-0280G” which is a product of Mitsui Chemical Corporation).

### Example 9

A pressure sensitive adhesive article was produced in the same manner as Example 2 except that the releasing agent layer was formed from olefin-based thermoplastic elastomer having a density of 0.900 g/cm³ (“EXCELLEN VL 100” which is a product of Sumitomo Chemical Co., Ltd.).

### Example 10

A pressure sensitive adhesive sheet was prepared in the same manner as Example 1 except that an antistatic layer (dried thickness: 0.5 μm) was formed on one surface of the polyethylene terephthalate film by the knife coating method, and then a pressure sensitive adhesive layer was formed on the antistatic layer by the knife coating method. A release sheet was prepared in the same manner as Example 1, and then the release sheet was superposed to the pressure sensitive adhesive sheet to produce a pressure sensitive adhesive article.

In this regard, it is to be noted that the antistatic layer was formed from a mixture of 100 parts by weight of tin oxide-based conductive filler (“SN-100P” which is a product of ISHIHARA SANGYO KAISHA, LTD.) and 50 parts by weight of polyester resin (“VYLON 20SS” which is a product of TOYOBO Co., Ltd.).

### Example 11

A pressure sensitive adhesive sheet was prepared in the same manner as Example 2. A release sheet was prepared in the same manner as Example 1 except that the temperature upon extrusion laminating was changed to 300° C.

### Comparative Example 1

A pressure sensitive adhesive sheet was prepared in the same manner as Example 1 except that an acrylic adhesive (“PL-shin” which is a product of LINTEC Corporation) was used as a constituent material of the pressure sensitive adhesive layer. A release sheet was prepared in the same manner as Example 1. The thus obtained release sheet was superposed to the pressure sensitive adhesive sheet to produce a pressure sensitive adhesive article.

### Comparative Example 2

A pressure sensitive adhesive sheet was prepared in the same manner as Comparative Example 1. As for a release sheet, a release sheet having a releasing agent layer formed from a silicone-based releasing agent (“8LK” which is a product of LINTEC Corporation) was used. The release sheet was superposed to the pressure sensitive adhesive sheet to produce a pressure sensitive adhesive article.

### Comparative Example 3

A pressure sensitive adhesive sheet was prepared in the same manner as Example 2. A release sheet was prepared in the same manner as Example 1 except that a releasing agent layer was formed from polyethylene having a density of 0.948 g/cm³ (“J-REX KM640A” which is a product of Japan Polyolefins Co., Ltd.) and that the temperature upon laminating was changed to 320° C. The thus obtained release sheet was superposed to the pressure sensitive adhesive sheet to produce a pressure sensitive adhesive article.

The kind of the resin used for the pressure sensitive adhesive layer, the kind of the resin used for the releasing agent layer and the density thereof, the temperature when forming the releasing agent layer, and the wetting tension at the surface of the releasing agent layer which faced the pressure sensitive adhesive layer of each of the pressure sensitive adhesive articles produced in Examples 1 to 11 and Comparative Examples 1 to 3 are shown in Table 1.

In this regard, it is to be noted that the density of the constituent material of the releasing agent layer was measured according to the method defined by JIS K 6922 1 and 2, and the wetting tension at the surface of the releasing agent layer which faced the pressure sensitive adhesive layer was measured according to the method defined by JIS K 6768.

### Evaluations for the Pressure Sensitive Adhesive Articles of Examples and Comparative Examples

The following evaluations were made with regard to each of the pressure sensitive adhesive articles (each of them was formed into a pressure sensitive adhesive sheet with a release sheet) produced according to Examples and Comparative Examples.

### (1) Writability on the Releasing Agent Layer

Some characters or the like were written onto the releasing agent layer of each of the release sheets (that is, the surface of the release sheet which has been in contact with the pressure sensitive adhesive layer) using a permanent felt-tip maker (“Hi-Mckee” which is a product name of Zebra Co., Ltd.), and then presence and absence of repellent of ink was observed with naked eyes. The case where no repellent of ink was observed was indicated by A, and the case where any repellent of ink was observed was indicated by B.

### (2) Slippage on the Releasing Agent Layer

Slippage on the releasing agent layer of each of the release sheets (that is, the surface of the release sheet which has been in contact with the pressure sensitive adhesive layer) was measured according to the slippage test method determined by JIS P 8147. The case where the slippage level was equal to or greater than 1 was indicated by A, and the case where the slippage level was less than 1 was indicated by B. In this regard, it is to be noted that a smaller value of the slippage level means that the releasing agent layer is more slippery.

### (3) Release Force

Release force was measured for each of the pressure sensitive adhesive articles under the condition that the release sheet was fixed onto a support plate, and then the pressure sensitive adhesive sheet was peeled off from the release sheet by pulling the pressure sensitive adhesive sheet toward the direction at an angle of 1800 with respect to the release sheet at a head speed of 0.3 m/min.

### (4) Amount of Silicone Compound

Each of the pressure sensitive adhesive articles was being left under the environment of an average temperature of about 23° C. and an average humidity of about 65% RH for 30 days after the preparation (production) thereof. After passing the 30 days, each pressure sensitive adhesive article was cut into a square of 10×10 cm. Then, the pressure sensitive adhesive sheet was peeled off from the release sheet. Using 10 ml of n-hexane at 23° C., the pressure-sensitive adhesive sheet was subjected to extraction, for 30 seconds. The extracted n-hexane was dried on an agate mortar. A tablet was prepared using the dried product obtained and 0.05 g of potassium bromide, and an amount of silicone compound in the tablet was measured with a beam condenser type FT-IR (a product of Perkin-Elmer Co.; trade name “PARAGON 1000”). The content of silicone compound per unit area of the pressure sensitive adhesive sheet was determined on the basis of the measurement result obtained using a calibration curve (measurement limit: 50 ∞g/m²).

The measured values below the measurement limit were indicated by “ND” in the tables.

### (5) Amount of Ions

Each of the pressure sensitive adhesive articles was being left under the environment of an average temperature of about 23° C. and an average humidity of about 65% RH for 30 days after the preparation (production) thereof. After passing the 30 days, each pressure sensitive adhesive article was cut into a square of 3×3 cm. Then, the pressure sensitive adhesive sheet was peeled off from the release sheet. Using 20 ml of pure water at 80° C., the pressure sensitive adhesive sheet was subjected to extraction for 30 minutes. Concentration of each of NOₓ⁻, Cl⁻, PO₄³⁻, F⁻, K⁺, Na⁺ and Ca²⁺ in the water obtained was analyzed and measured using an ion chromatoanalyzer (a product of Yokokawa Electric Co.: trade name “IC500”). The sum of those ions contained in the pressure sensitive adhesive sheet per unit area was determined on the basis of the measurement results obtained (measurement limit: 5 μg/m²).

The measured values below the measurement limit were indicated by “ND” in the tables. (6) Amount of Gas Generated

Each of the pressure sensitive adhesive articles was being left under the environment of an average temperature of about 23° C. and an average humidity of about 65% RH for 30 days after the preparation (production) thereof. After passing the 30 days, the pressure sensitive adhesive article was cut into a square of 5×4 cm. Then, the pressure sensitive adhesive sheet was peeled off from the release sheet. The pressure sensitive adhesive sheet was placed in a head space bottle having a volume of 50 ml. While helium gas at 85° C. was being flown in the head space bottle at a flow rate of 50 ml/min for 30 minutes, the gas flown out of the head space bottle was collected with a purge and trap apparatus (a product of Nippon Bunseki Kogyo K.K.: trade name “JHS-100A”) containing a tenax collector cooled to −60° C. The gas collected was gasified with a pyrolyzer and analyzed with GC-MS (a product of Hewlett-Packard Co.; trade name “5890-5971A”). Amount of the gas generated from the pressure sensitive adhesive sheet per unit area was determined on the basis of the measurement results obtained (measurement limit: 20 μg/m²).

The measured values below the measurement limit were indicated by “ND” in the tables.

### (7) Degree of Residual Adhesive

After a plurality of samples of each of the pressure sensitive adhesive sheets were attached to various adherends, they were being left for one day at a temperature of 70° C. Then, the samples were peeled off from the adherends, and in each of the adherends, the degree of the residual adhesive was observed with naked eyes. The evaluation was made according to the following four rankings.

A: no residual adhesive was observed on the adherend

B: a bit of residual adhesive was observed on the adherend

C: adhesive was transferred to the adherend in some locations on the adherend

D: adhesive was completely transferred to the adherend

### (8) Count of Generated Particles having a Diameter of 0.1 μm or More

Each of the pressure sensitive adhesive articles was being left under the environment of an average temperature of about 23° C. and an average humidity of about 65% RH for 30 days from the preparation (production) thereof. After passing the 30 days, tests of the following three items of crumpling, friction, and tear and crumpling were conducted to observe generation of particles having a diameter of 0.1 μm or more according to “Test Method for the Measurement of Particle Generation from Sheet Materials” determined by SEMI (Semiconductor Equipment and Material International) G67-0996 (which corresponds to the Semiconductor Production Apparatus and Material International Associate Doc. No. 2362).

Crumpling: An A5 size pressure sensitive adhesive article was crumpled for 200 seconds at a rate of one time in 15 seconds.

Friction: Two A5 size pressure sensitive adhesive articles were prepared, and the front of one pressure sensitive adhesive article and the back of another pressure sensitive adhesive article were superposed, and the laminate thus obtained was rubbed with the palms of the hands at a rate of three times in 10 seconds for 200 seconds.

Tear and crumpling: Four portions (4 cm intervals) of an A5 size pressure sensitive adhesive article were torn every 5 seconds, and then crumpled for 180 seconds in the same manner as in the crumpling test.

### (9) Suitability for Labeling Machine

Using a labeling machine MD-1 (product code of Lintec Corporation), 10 sheets of the pressure sensitive adhesive sheet (label) were successively discharged from the machine during one minute, and at this time the observation was made as to whether these sheets were properly discharged or not. The result of the observation was evaluated according to the following three rankings.

A: the sheets were properly discharged

B: it was necessary to lower the discharge speed for properly discharging these sheets

C: proper discharge of these sheets could not be carried out

### (10) Surface Resistivity

Measurement of surface resistivity was carried out based on the pressure sensitive adhesive sheets of the pressure sensitive adhesive articles having the antistatic layers produced in Example 10 and Comparative Example 2. These sheets were being left under the environment of an average temperature of about 23° C. and an average humidity of 65% RH for 24 hours. After the above time, the pressure sensitive adhesive sheets were cut into a square of 10×10 cm, respectively.

Then, surface resistivities of the surfaces of the pressure sensitive adhesive layers of the pressure sensitive adhesive sheets were measured in accordance with JIS K 6911 using a surface resistivity measurement apparatus (a product of Advantest Co.: trade name “R-12704”).

### (11) Voltage of Electrification at Peeling-Off

The pressure sensitive adhesive articles produced in Example 10 and Comparative Example 2 were being left under the environment of an average temperature of about 23° C. and an average humidity of about 65% RH for 30 days after the preparation (production) thereof. After passing the 30 days, each of the pressure sensitive adhesive articles was cut into a square of 10×10 cm, respectively. Then, in each of the pressure sensitive adhesive articles, the pressure sensitive adhesive sheet was peeled off from the release sheet at a rate of 500 mm/min. At this time, charged potential charged onto each pressure sensitive adhesive sheet was measured from a distance of 50 mm with a current collecting potential measurement apparatus (a product of Kasuga Denki K.K.: trade name “KSD-6110”) under the environment of a temperature of 23° C. and a humidity of 65% RH (measurement lower limit: 0.1 kV).

The results of the evaluations are shown in Tables 2 and 3.

As shown in Tables 1 and 2, in each of the pressure sensitive adhesive articles of the present invention (Examples 1-11), the required release force was small and thus satisfactory releasability was obtained. Further, transferring of the silicone compound to the surface of the pressure sensitive adhesive layer was not detected. Furthermore, residual adhesive was not observed. In particular, the pressure sensitive adhesive articles having the releasing agent layers made of polyolefin resin of a density of 0.94 g/cm³ or less and the wetting tension of the release sheet at the surface facing the pressure sensitive adhesive layer of 33 mN/m or less (Examples 1-5 and 7-10) exhibited especially excellent performances and properties.

In contrast with these Examples, the pressure sensitive adhesive articles of Comparative Examples showed poor performances and properties.

Further, as seen from Table 3, it has been confirmed that the pressure sensitive adhesive article of Example 10 had smaller surface resistivity as compared with the pressure sensitive adhesive article of Comparative Example 2, and in the pressure sensitive adhesive article of Example 10 almost no voltage of electrification at peeling-off was generated.

From the results described above, it has been found that by using polyurethane resin as a constituent material of the pressure sensitive adhesive layer and using polyolefin resin that satisfies predetermined requirements as a constituent material of the releasing agent layer, it is possible to provide a pressure sensitive adhesive article that is hard to give adverse effects caused by silicone compound and that can be peeled off from the release sheet with a small release force so as to have good handlability.

Further, it has been also found that by adopting the above mentioned constituent structures, it is possible to realize a pressure sensitive adhesive article having excellent releasability with no residual adhesive. Further, it has also been confirmed that such a pressure sensitive adhesive article can also have excellent characteristics that the resin constituting the releasing agent layer does not fall off and voltage of electrification at peeling-off is not generated.

Furthermore, it has been also confirmed that since in the pressure sensitive adhesive articles of Examples of the present invention, transferring of silicone compound to the pressure sensitive adhesive layers hardly occurs, they can be preferably used for manufacturing and assembling processes of electronic equipment and electronic components such as hard disk drives, semiconductor devices, relays and the like and final products thereof that dislike contamination by silicone.

Moreover, in each of the pressure sensitive adhesive articles of Examples 1 to 11, excellent results as to the evaluation tests (1) writability on releasing agent layer and (2) slippage on releasing agent layer were obtained as shown in Table 2. This means that when the pressure sensitive adhesive article of the present invention is formed into a pressure sensitive adhesive tape having a releasing agent layer that is the same as that of the release sheet of the pressure sensitive adhesive article obtained in any one of these Examples, such a pressure sensitive adhesive tape also exhibits excellent properties as to writability on releasing agent layer and slippage on releasing agent layer. Thus, such a pressure sensitive adhesive tape is also well suited for practical use, as is the same as the case of the pressure sensitive adhesive sheet with a release sheet.

As described above, according to the present invention, it is possible to provide a pressure sensitive adhesive article which hardly give adverse effects caused by silicone compound and which has an improved releasability that makes it possible to peel off a release sheet with a small release force at a boundary between a releasing agent layer of the release sheet and a pressure sensitive adhesive layer.

These effects can be made more conspicuous by adjusting the composition, molecular weight, density of the polyurethane resin contained in the pressure sensitive adhesive layer and/or the polyolefin resin contained in the releasing agent layer and/or by adjusting the conditions for forming the releasing agent layer.

Finally, it is to be understood that many changes and additions may be made to the embodiments described above without departing from the scope and spirit of the invention as defined in the following claims.

TABLE 1

| | | Releasing agent layer | | | Temperature of | |
|---|---|---|---|---|---|---|
| | | | | Number | material when | Wetting |
| | Pressure sensitive | | | average | forming | tension at |
| | adhesive layer | | Density of | molecular | releasing | releasing |
| | Constituent | Constituent | used resin | weight of | agent layer | agent layer |
| | material | material | (g/cm³) | used resin | (° C.) | (mN/m) |
| Example 1 | Urethane-urea | Ethylene-propylene | 0.870 | 100,000 | 260 | 31 |
| | | copolymer | | | | |
| | | Polyethylene | 0.916 | 150,000 | | |
| Example 2 | Urethane | Ethylene-propylene | 0.870 | 100,000 | 260 | 31 |
| | | copolymer | | | | |
| | | Polyethylene | 0.916 | 150,000 | | |
| Example 3 | Urethane | Polyethylene | 0.916 | 150,000 | 260 | 31 |
| Example 4 | Urethane | Polyethylene | 0.912 | 34,000 | 260 | 31 |
| Example 5 | Urethane | Polyethylene | 0.936 | 120,000 | 260 | 32 |
| Example 6 | Urethane | Polyethylene | 0.948 | 89,000 | 260 | 33 |
| Example 7 | Urethane | Polypropylene | 0.890 | 41,000 | 260 | 31 |
| Example 8 | Urethane | Ethylene-propylene | 0.870 | 100,000 | 260 | 31 |
| | | copolymer | | | | |
| Example 9 | Urethane | Ethylene α-olefin | 0.900 | 25,000 | 260 | 31 |
| | | copolymer | | | | |
| Example 10 | Urethane | Ethylene-propylene | 0.870 | 100,000 | 260 | 31 |
| | | copolymer | | | | |
| | | Polyethylene | 0.916 | 150,000 | | |
| Example 11 | Urethane | Ethylene-propylene | 0.870 | 100,000 | 300 | 34 |
| | | copolymer | | | | |
| | | Polyethylene | 0.916 | 150,000 | | |
| Comp. Ex. 1 | Acryl | Ethylene-propylene | 0.870 | 100,000 | 260 | 31 |
| | | copolymer | | | | |
| | | Polyethylene | 0.916 | 150,000 | | |
| Comp. Ex. 2 | Acryl | Silicone | — | — | — | less than 31 |
| Comp. Ex. 3 | Urethane | Polyethylene | 0.948 | 89,000 | 320 | 36 |

TABLE 2

| | | | | | | | | Count of | |
|---|---|---|---|---|---|---|---|---|---|
| | Writability | | Release | | | | Degree | particles | |
| | on | Slippage on | force at | Amount of | | Amount of | of | generated | Suitability |
| | releasing | releasing | 0.3 m/min | silicone | Amount | gas | residual | (particles/ | for labeling |
| | agent layer | agent layer | (mN/50 mm) | (μg/m²) | of ions | generated | adhesive | L) | machine |
| Example 1 | A | A | 90 | ND | ND | ND | A | 0 | A |
| Example 2 | A | A | 90 | ND | ND | ND | A | 0 | A |
| Example 3 | A | A | 120 | ND | ND | ND | A | 0 | A |
| Example 4 | A | A | 110 | ND | ND | ND | A | 0 | A |
| Example 5 | A | A | 130 | ND | ND | ND | A | 0 | A |
| Example 6 | A | A | 150 | ND | ND | ND | A | 0 | B |
| Example 7 | A | A | 140 | ND | ND | ND | A | 0 | A |
| Example 8 | A | A | 110 | ND | ND | ND | A | 0 | A |
| Example 9 | A | A | 120 | ND | ND | ND | A | 0 | A |
| Example 10 | A | A | 90 | ND | ND | ND | A | 0 | A |
| Example 11 | A | A | 190 | ND | ND | ND | A | 0 | B |
| Comp. Ex. 1 | A | A | 200 | ND | ND | ND | D | 0 | B |
| Comp. Ex. 2 | B | B | 100 | 6,500 | ND | ND | D | 1,200 | A |
| Comp. Ex. 3 | A | A | 520 | ND | ND | ND | A | 0 | C |

TABLE 3

| | | Voltage of |
|---|---|---|
| | | electrification at |
| | Surface resistivity | peeling-off |
| | (Ω) | (kV) |
| Example 10 | ^{1.0 × 10}⁵ | ND |
| Comp. Ex. 2 | ^{1.0 × 10}¹⁴ | 5 |

1. A pressure sensitive adhesive article, comprising:
a pressure sensitive adhesive layer mainly formed of polyurethane resin; and
a releasing agent layer mainly formed of polyolefin resin, which is adhered to the pressure sensitive adhesive layer, wherein wetting tension at the surface of the releasing agent layer which faces the pressure sensitive adhesive layer measured according to the wetting tension test defined by JIS K 6768 is equal to or less than 33 mN/m.

2. A pressure sensitive adhesive article, comprising:
a pressure sensitive adhesive layer mainly formed of polyurethane resin; and
a releasing agent layer mainly formed of polyolefin resin having a density of equal to or less than 0.94 g/cm³, which is adhered to the pressure sensitive adhesive layer.

3. A pressure sensitive adhesive article, comprising:
a pressure sensitive adhesive layer mainly formed of polyurethane resin; and
a releasing agent layer mainly formed of polyolefin resin having a density of equal to or less than 0.94 g/cm³, which is adhered to the pressure sensitive adhesive layer, wherein wetting tension at the surface of the releasing agent layer which faces the pressure sensitive adhesive layer measured according to the wetting tension test defined by JIS K 6768 is equal to or less than 33 mN/m.

4. The pressure sensitive adhesive article as claimed in claim 1, wherein the pressure sensitive adhesive article is a pressure sensitive adhesive sheet with a release sheet, which comprises:
a pressure sensitive adhesive sheet including a base material on which the pressure sensitive adhesive layer is provided, and
a release sheet including a release sheet base material on which the releasing agent layer is provided, the release sheet being removably attached to the pressure sensitive adhesive layer of the pressure sensitive adhesive sheet through the releasing agent layer thereof.

5. The pressure sensitive adhesive article as claimed in claim 4, wherein even if the pressure sensitive adhesive sheet having the pressure sensitive adhesive layer contains silicone compound, the content thereof is 500 g/m² or less.

6. The pressure sensitive adhesive article as claimed in claim 4, wherein when the pressure sensitive adhesive sheet is used after it has been peeled off from the release sheet, the pressure sensitive adhesive sheet may generate a gas at a temperature of 85° C. for 30 minutes, but the amount of the gas generated from the pressure sensitive adhesive sheet is equal to or less than 20 mg/m².

7. The pressure sensitive adhesive article as claimed in claim 4, wherein when the pressure sensitive adhesive sheet is used after it has been peeled off from the release sheet, the pressure sensitive adhesive sheet contains ions of NOₓ⁻, Cl⁻, PO₄³⁻, F⁻, K⁺, Na⁺ and Ca²⁺, but the sum of amounts of these ions is equal to or less than 20 mg/m².

8. The pressure sensitive adhesive article as claimed in claim 4, wherein the base material of the pressure sensitive adhesive sheet is formed from a plastic film or a lint-free paper.

9. The pressure sensitive adhesive article as claimed in claim 4, wherein the pressure sensitive adhesive sheet further comprises at least one antistatic layer provided on one or both of the surfaces of the base material.

10. The pressure sensitive adhesive article as claimed in claim 1, wherein the pressure sensitive adhesive article is a pressure sensitive adhesive tape which comprises a base material having both surfaces, the pressure sensitive adhesive layer provided on one of the surfaces of the base material and the releasing agent layer provided on the other surface of the base material, wherein the pressure sensitive adhesive tape being wound in a roll form until it is used.

11. The pressure sensitive adhesive article as claimed in claim 10, wherein even if the pressure sensitive adhesive tape having the pressure sensitive adhesive layer contains silicone compound, the content thereof is 500 g/m² or less.

12. The pressure sensitive adhesive article as claimed in claim 10, wherein when the pressure sensitive adhesive tape is used, the pressure sensitive adhesive tape may generate a gas at a temperature of 85° C. for 30 minutes, but the amount of the gas generated from the pressure sensitive adhesive tape is equal to or less than 20 mg/m².

13. The pressure sensitive adhesive article as claimed in claim 10, wherein when the pressure sensitive adhesive tape is used, the pressure sensitive adhesive tape contains ions of NOₓ⁻, Cl⁻, PO₄³⁻, F⁻, K⁺, Na⁺ and Ca²⁺, but the sum of amounts of these ions is equal to or less than 20 mg/m².

14. The pressure sensitive adhesive article as claimed in claim 10, wherein the base material of the pressure sensitive adhesive tape is formed from a plastic film or a lint-free paper.

15. The pressure sensitive adhesive article as claimed in claim 10, wherein the pressure sensitive adhesive tape further comprises at least one antistatic layer provided on one or both of the surfaces of the base material.
